(19) United States
(12) Patent Application Publication
(10) Pub. No.: US 2009/0138535 A1
(43) Pub. Date: May 28, 2009

(54) Novel Binary and n-State Linear Feedback Shift Registers (LFSRs)

(76) Inventor: Peter Lablans, Morris Township, NJ (US)

Correspondence Address: DIEHL SERVILLA LLC, 77 BRANT AVE, SUITE 210, CLARK, NJ, 07066, US

(21) Appl. No.: 12/323,070

(22) Filed: Nov. 25, 2008

Related U.S. Application Data
(60) Provisional application No. 60/990,071, filed on Nov. 26, 2007.

(51) Int. Cl. G06F 7/58

(52) U.S. Cl. 708/252

(57) ABSTRACT

N-state with n equal or greater than 2 modified Linear Feedback Shift Registers (mLFSRs) having a non-reversible n-state switching function have been disclosed. An mLFSR can also contain a device that implements an n-state logic function of which one input is provided with a signal external to the mLFSR. The mLFSR can be in Fibonacci or in Galois configurations. N-state scramblers and corresponding descramblers applying an mLFSR are provided. N-state coding boxes apply non-reversible switching functions connected to n-state scrambling or descrambling functions. Sequence generators and detectors are also disclosed.

### CROSS-REFERENCE TO RELATED APPLICATIONS

This application claims the benefit of U.S. Provisional Application No. 60/990,071, filed on Nov. 26, 2007 which is incorporated herein by reference in its entirety.

### BACKGROUND OF THE INVENTION

This invention relates to binary and n-state Linear Feedback Shift Registers (LFSRs). More specifically it relates to novel methods and apparatus to implement binary and n-state LFSRs using non-reversible switching functions.

LFSRs in binary form are known in Fibonacci and in Galois configuration. They are also known in binary switching implementation and, as shown by the inventor, in for instance United States Patent Publication No. 2005/0185796 A1, dated Aug. 25, 2005, entitled TERNARY AND MULTI-VALUE DIGITAL SCRAMBLERS, DESCRAMBLERS AND SEQUENCE GENERATORS, which is incorporated herein by reference, in different n-valued or n-state implementations.

LFSRs are often used in scramblers and descramblers. The purpose of scrambling a message may be to encipher the signal and to make reading the message difficult for an unauthorized party. LFSRs are currently using reversible binary or n-state switching functions. This makes the structure of an LFSR potentially predictable to an unauthorized party that wants to decipher a scrambled message, as the party may assume that only reversible switching functions are used.

Accordingly, novel and improved binary and n-state LFSRs are required that apply also non-reversible binary or n-state switching functions.

### SUMMARY OF THE INVENTION

In view of the more limited possibilities of the prior art in creating binary or n-valued or n-state LFSRs and coders novel and improved apparatus and methods to create n-state symbol coders and decoders is required.

The general purpose of the present invention, which will be described subsequently in greater detail, is to provide novel methods and apparatus which can be applied in the creation of binary and multi-valued or n-state coders and decoders. Individual n-state symbols may be represented by a signal characterized by an independent instance of a physical phenomenon. Signals can be of an electrical or optical nature, but they may be of any valid distinguishable physical phenomenon, including by an independent material such as a bio-chemical material. An n-state symbol may also be represented by a plurality of symbols.

Before explaining at least one embodiment of the invention in detail, it is to be understood that the invention is not limited in its application to the details of construction and to the arrangements of the components or methods set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Binary in the context of this application means 2-valued or 2-state. Multi-valued, n-valued or n-state in the context of this invention means an integer greater than 2.

One object of the present invention is to provide novel coding boxes applying a non-reversible switching function.

In accordance with one aspect of the present invention, an n-state Linear Feedback Shift Register (LFSR) with n≧2 is provided, comprising a shift register of 1 or more shift register elements, a shift register element enabled to store an n-state symbol or a representation of an n-state symbol, and at least one non-reversible n-state switching function.

In accordance with another aspect of the present invention, the n-state LFSR has n>2.

In accordance with a further aspect of the present invention, an n-state LFSR is provided, wherein the LFSR is part of a scrambler, the scrambler having a corresponding descrambler.

In accordance with another aspect of the present invention, an n-state LFSR is provided, wherein the LFSR is an LFSR in Fibonacci configuration.

In accordance with a further aspect of the present invention, an n-state LFSR is provided, wherein the LFSR is an LFSR in Galois configuration.

In accordance with another aspect of the present invention, an n-state coder with n≧2 for coding a plurality of n-state symbols is provided, comprising a scrambling function being an n-state reversible switching function having a first and a second input and an output, the plurality of n-state symbols being provided on the first input, an n-state coding box including an input and an output, the input enabled to receive an n-state symbol and the output enabled to provide an n-state symbol, the coding box including at least one non-reversible n-state switching function, the output of the n-state coding box connected to the second input of the scrambling function, the output of the scrambling function providing a plurality of coded n-state symbols, and the output of the scrambling function being connected to the input of the coding box.

In accordance with a further aspect of the present invention, an n-state coder is provided, further comprising a corresponding decoder.

In accordance with another aspect of the present invention, an n-state coder is provided, wherein the coding box includes a Linear Feedback Shift Register (LFSR).

In accordance with a further aspect of the present invention, an n-state coder is provided, wherein the LFSR is a Fibonacci LFSR.

In accordance with another aspect of the present invention, an n-state coder is provided, wherein the LFSR is a Galois LFSR.

In accordance with a further aspect of the present invention, an n-state coder is provided, wherein the coding box is reconfigured after processing at least 1 n-state symbol.

In accordance with another aspect of the present invention, an n-state coder is provided, wherein the corresponding decoder is self-synchronizing.

In accordance with a further aspect of the present invention, an n-state coder is provided, wherein each of the plurality of n-state symbols only assume 1 of p states with p<n.

In accordance with another aspect of the present invention, an n-state coder is provided, the coding box of the coder further comprising a second input, the second input enabled to receive a key sequence.

In accordance with a further aspect of the present invention, an n-state coder is provided, the coding box of the coder further comprising a third input, the third input enabled to receive the plurality of n-state symbols.

In accordance with an aspect of the present invention, an n-state with n≧2 modified Linear Feedback Shift Register (mLFSR) is provided, comprising an input enabled to receive a signal having one of n states and an output, a shift register having at least 2 shift register elements, each shift register element enabled to store a signal having one of n states, at least one device implementing a first 2-place n-state logic function, the device having a first input, a second input and an output; wherein a signal external to the mLFSR is provided on the first input.

In accordance with another aspect of the present invention, an n-state mLFSR is provided, wherein n>2.

In accordance with yet another aspect of the present invention, an n-state mLFSR is provided, wherein the signal external to the mLFSR can be switched between at least two modes.

In accordance with yet another aspect of the present invention, an n-state mLFSR is provided, further comprising a second device implementing a reversible 2-place n-state logic function, the second device having a first input, a second input and an output, wherein the first input is enabled to receive a first n-state signal, the second input is connected to the output of the mLFSR and the output of the second device is connected to the input of the LFSR, and an output enabled to provide a first processed n-state signal.

In accordance with yet another aspect of the present invention, an n-state mLFSR is provided, further comprising a third device implementing a second reversible 2-place n-state logic function, the third device having a first input, a second input and an output, wherein the first input is enabled to receive a second n-state signal, the second input is connected to the output of the mLFSR, the output of the third device provides a second processed n-state signal and the second n-state signal is also provided on the input of the mLFSR.

In accordance with yet another aspect of the present invention, an n-state mLFSR is provided, further comprising connecting the output of the mLFSR with the input of the mLFSR and an output enabled to provide an n-state sequence of signals.

In accordance with yet another aspect of the present invention, an n-state mLFSR is provided, wherein the mLFSR is part of a communication system.

In accordance with yet another aspect of the present invention, an n-state mLFSR is provided, wherein the mLFSR is part of a storage system.

In accordance with yet another aspect of the present invention, an n-state mLFSR is provided, wherein the mLFSR is part of a playing device.

In accordance with yet another aspect of the present invention, an n-state mLFSR is provided, wherein the mLFSR is part of a scrambler/descrambler system.

In accordance with a further aspect of the present invention, a method is provided for processing an n-state signal with n≧2 with a modified Linear Feedback Shift Register (mLFSR), comprising, inputting the n-state signal on an input of a shift register element of the mLFSR, the mLFSR having at least two shift register elements, the mLFSR including an output, inputting a signal that depends on the n-state signal on a first input of a first device implementing a 2-place n-state logic function that also includes a second input and an output, inputting a signal external to the mLFSR on the second input of the first device, and outputting on the output of the first device a first processed n-state signal.

In accordance with yet a further aspect of the present invention, a method is provided for processing an n-state signal with n≧2 with a modified Linear Feedback Shift Register (mLFSR), wherein n>2.

In accordance with yet a further aspect of the present invention, a method is provided for processing an n-state signal with n≧2 with a modified Linear Feedback Shift Register (mLFSR), wherein the signal external to the mLFSR can be switched between at least two modes.

In accordance with yet a further aspect of the present invention, a method is provided for processing an n-state signal with n≧2 with a modified Linear Feedback Shift Register (mLFSR), further comprising inputting a second n-state signal on a first input of a second device implementing a reversible 2-place n-state logic function connecting a second input of the second device to the output of the mLFSR, connecting an output of the second device an input of the LFSR, and outputting a second processed n-state signal on an output of the second device.

In accordance with yet a further aspect of the present invention, a method is provided for processing an n-state signal with n≧2 with a modified Linear Feedback Shift Register (mLFSR), further comprising inputting a third n-state signal on a first input of a third device implementing a reversible 2-place n-state logic function, connecting a second input of the second device to the output of the mLFSR, providing the third n-state signal on an input of the LFSR, and outputting a third processed n-state signal on an output of the third device.

In accordance with yet a further aspect of the present invention, a method is provided for processing an n-state signal with n≧2 with a modified Linear Feedback Shift Register (mLFSR), further comprising connecting the output of the mLFSR with the input of the mLFSR and outputting on an output an n-state sequence of signals.

In accordance with yet a further aspect of the present invention, a method is provided for processing an n-state signal with n≧2 with a modified Linear Feedback Shift Register (mLFSR), wherein the mLFSR is part of a communication system.

In accordance with yet a further aspect of the present invention, a method is provided for processing an n-state signal with n≧2 with a modified Linear Feedback Shift Register (mLFSR), wherein the mLFSR is part of a storage system.

In accordance with yet a further aspect of the present invention, a method is provided for processing an n-state signal with n≧2 with a modified Linear Feedback Shift Register (mLFSR), wherein the mLFSR is part of a playing device.

In accordance with yet a further aspect of the present invention, a method is provided for processing an n-state signal with n≧2 with a modified Linear Feedback Shift Register (mLFSR), wherein the mLFSR is part of a scrambler/descrambler system.

### BRIEF DESCRIPTION OF THE DRAWINGS

Various other objects, features and attendant advantages of the present invention will become fully appreciated as the same becomes better understood when considered in conjunction with the accompanying drawings, and wherein:

FIG. 1 is a diagram of an n-state LFSR based scrambler with n≧2;

FIG. 2 is a diagram of an n-state LFSR based sequence generator with n≧2;

FIG. 3 is another diagram of an n-state LFSR based scrambler with n≧2;

FIG. 4 is another diagram of an n-state LFSR based sequence generator with n≧2;

FIG. 5 is yet another diagram of an n-state LFSR;

FIG. 6 is yet another diagram of an n-state LFSR;

FIG. 7 is a diagram of an n-state LFSR based scrambler;

FIG. 8 is a diagram of an n-state LFSR based descrambler;

FIG. 9 is a diagram of an n-state LFSR based scrambler with a corresponding n-state LFSR based descrambler;

FIG. 10 is a diagram of an n-state coder in accordance with an aspect of the present invention;

FIG. 11 is a diagram of an n-state decoder in accordance with an aspect of the present invention;

FIG. 12 is a diagram of an n-state coder with a corresponding n-state decoder in accordance with an aspect of the present invention;

FIG. 13 is another diagram of an n-state coder with a corresponding n-state decoder in accordance with an aspect of the present invention;

FIG. 14 is another diagram of an n-state coder in accordance with an aspect of the present invention;

FIG. 15 is a diagram of an n-state coder box in accordance with an aspect of the present invention;

FIG. 16 is another diagram of an n-state decoder in accordance with an aspect of the present invention;

FIG. 17 is a diagram of an n-state coder box in accordance with an aspect of the present invention;

FIG. 18 is a diagram of an n-state sequence generator in accordance with an aspect of the present invention;

FIG. 19 is a diagram of a detector of an n n-state sequence in accordance with an aspect of the present invention;

FIG. 20 is a diagram of a scrambler/descrambler combination with a modified Linear Feedback Shift Register (mLFSR) in accordance with an aspect of the present invention;

FIG. 21 is a diagram of a scrambler with a modified Linear Feedback Shift Register (mLFSR) in accordance with an aspect of the present invention;

FIG. 22 is a diagram of another scrambler/descrambler combination with a modified Linear Feedback Shift Register (mLFSR) in accordance with an aspect of the present invention;

FIG. 23 is a diagram of another scrambler/descrambler combination with a modified Linear Feedback Shift Register (mLFSR) in accordance with an aspect of the present invention;

FIG. 24 is a diagram of another scrambler with a modified Linear Feedback Shift Register (mLFSR) in accordance with an aspect of the present invention;

FIG. 25 is a diagram of another scrambler/descrambler combination with a modified Linear Feedback Shift Register (mLFSR) in accordance with an aspect of the present invention;

FIG. 26 is a diagram of an n-state sequence generator;

FIG. 27 is an autocorrelation graph of a sequence;

FIG. 28 is a diagram of a sequence generator with a modified Linear Feedback Shift Register (mLFSR) in accordance with an aspect of the present invention;

FIG. 29 is a combined correlation graph;

FIG. 30 is a diagram of another sequence generator with a modified Linear Feedback Shift Register (mLFSR) in accordance with an aspect of the present invention;

FIG. 31 is another combined correlation graph;

FIG. 32 is a diagram of system in accordance with an aspect of the present invention;

FIG. 33 is a diagram of a transmission system in accordance with an aspect of the present invention; and

FIG. 34 is a diagram of a receiving system in accordance with an aspect of the present invention.

### DETAILED DESCRIPTION OF THE INVENTION

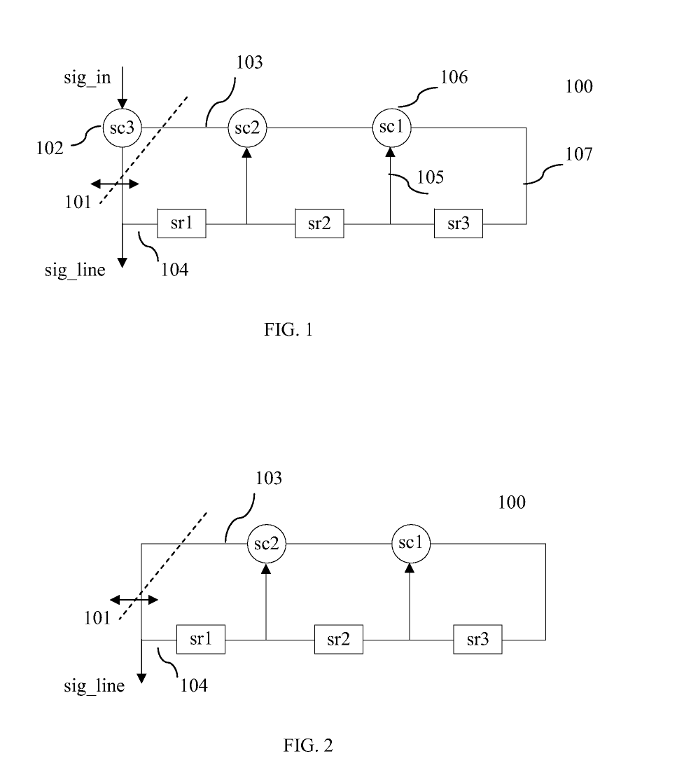

Aspects of the present invention provide novel implementation of n-valued with n>2 and binary Linear Feedback Shift Registers (LFSRs). An LFSR usually appears in one of two configurations: the Fibonacci and the Galois configuration. As an illustrative example an LFSR in Fibonacci configuration 100 is provided in FIG. 1. The diagram of FIG. 1 may be used as a scrambler and has a corresponding descrambler.

The LFSR in the diagram is the part to the right of line 100. It has the 3 connected shift register elements sr1, sr2 and sr3. Each shift register element has at least one input and one output. As drawn in FIG. 1, the output of shift register element sr1 is connected to the input of shift register element sr2. The output of shift register element sr2 is connected to the input of shift register element sr3. The output of shift register element sr3 is connected to one input of an n-state switching function sc1. An LFSR may also have more or fewer shift register elements. A shift register element can preserve an entity which represents a binary or n-state symbol and is a memory element. It can thus contain a signal that is a single element, for instance a single electrical signal that can have, for instance, one of 4 values and represents thus a 4-state symbol. It may also contain a plurality of p-state signals which represents an n-state symbol. For instance, a 4-state symbol can be represented a 2 bits or 2 binary signals. In that case, a shift register element contains 2 signals and may, for instance, be formed out of 2 binary elements. Single n-state elements have been disclosed by the applicant in U.S. Pat. No. 7,397,690, dated Jul. 8, 2008, entitled MULTI-VALUED DIGITAL INFORMATION RETAINING ELEMENTS AND MEMORY DEVICES, which is incorporated herein by reference.

The shift register elements work in general under a control or clock signal. In order to keep the diagrams herein uncluttered, these control signals are assumed but not shown. When the control signal is in a first state the shift register element retain their value or state and provide their content on their respective outputs. When the control signal is in a second state each element still provides the retained signal on their output; however they also store the signal on their inputs in memory. When the control signal has no longer the second state, the retained value or signal is the newly entered signal from the input and is provided on the outputs. Even if a signal at an input changes the signal at the output remains the newly stored signal. Accordingly, the states of the shift register are in the LFSR of FIG. 1 shifted from left to right. At the last shift register element sr3 the state is shifted out of the shift register.

In case an n-state symbol is represented by two or more signals, the shift registers are assumed to shift per clock pulse an n-state symbol, which are then 2 or more signals.

Another characteristic of the LFSR is that at least the output of the last element of the shift register is fed back into an input of the LFSR. In the Fibonacci LFSR of FIG. 1 the last element is sr3. The output element is connected through a connection 107 to a first input of an n-state function sc1 106. An output of this function is connected to an input of a function sc2. The output of function sc2 is 103 which is the output of the LFSR. In this case the LFSR is part of a scrambler which applies an n-state scrambling function 102 sc3. The function sc3 is provided to be scrambled symbols sig_in. The scrambled symbols sig_line are provided on output 101. Output 101 is connected to input 104 of the first element sr1 of the shift register. The input 104 of the first element of the shift register is also the input of the LFSR. Accordingly, the output of the LFSR is the output of the function that is connected to the output of the first shift register element or if the first shift register element has no feedback tap, then the one closest to the first element that has a feedback tap on its output. Accordingly, the input of the LFSR in FIG. 1 is 104 and the output is 103.

A descrambler corresponding to the scrambler of FIG. 1 would use the same LFSR 100.

FIG. 2 is a diagram of the same LFSR 100 as in FIG. 1 with output 103 and input 104. In FIG. 2, a sequence generator is shown. No external symbols are required and output 103 is directly connected to input 104.

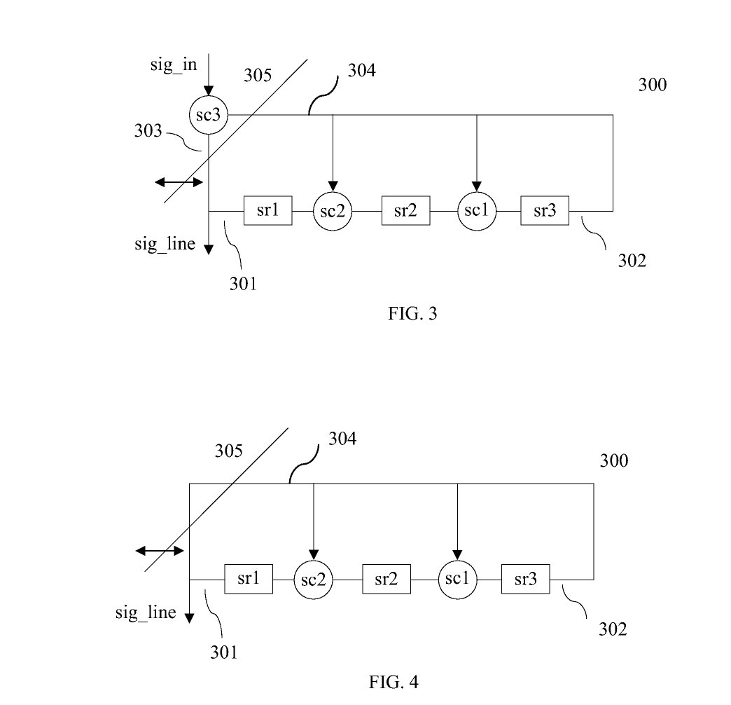

FIG. 3 shows an n-state scrambler using an LFSR 300 in Galois configuration. The n-state switching functions in Galois are connected between an output of a preceding shift register element and the input of a succeeding shift register element. All n-state switching functions in a Galois LFSR are connected to the output 302 of the last shift register element sr3. The Galois LFSR 300 of FIG. 3 is shown to the right of line 305. The input of the LFSR 300 is 301, its output is 304. FIG. 3 shows a scrambler wherein output and input of the LFSR are connected through a scrambling function sc3 with output 303 which is connected to 301.

FIG. 4 shows the same Galois LFSR 300 used in a sequence generator wherein again no external input symbols are required and wherein output 304 is directly connected to input 301.

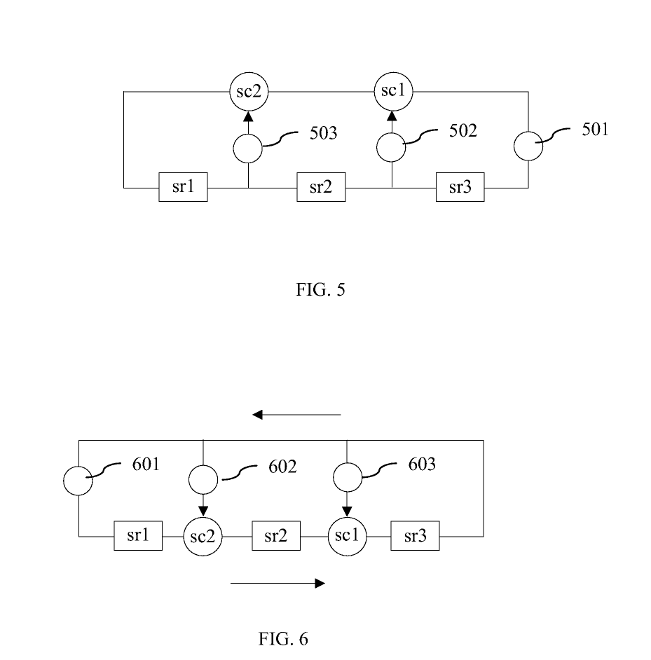

The above are just illustrative examples of Fibonacci and Galois LFSRs. Other configurations are possible and are fully contemplated. For instance, one may provide n-state or n-valued inverters in the LFSR. An example is provided in FIG. 5 for the LFSR of FIG. 1 now provided with n-valued or n-state inverters 501, 502 and 503 which may be n-valued multipliers.

A Galois LFSR with inverters 601, 602 and 603 is provided in FIG. 6.

In FIG. 5 and FIG. 6, the designations for input and output have been removed. It should be clear to one of ordinary skill in the art that different locations in an LFSR may be selected as input or output.

Further configurations of LFSRs are fully contemplated and are, for instance, disclosed by the applicant in U.S. Patent Pub. No. 2007/0239812 A1, Oct. 11, 2007, which is incorporated herein by reference.

In accordance with an aspect of the present invention, an LFSR is provided with at least one binary n-state switching function in the LFSR being non-reversible. Non-reversible function in the context of the present invention means that when an n-state or binary function has p inputs and 1 output one may say that an equation determining the relation between input and output variables has (p+1) variables. Such an equation is reversible when at any time p variables (which may include an output variable) determines a (p+1)th variable. For instance, the binary XOR function is reversible, while the binary AND function is not.

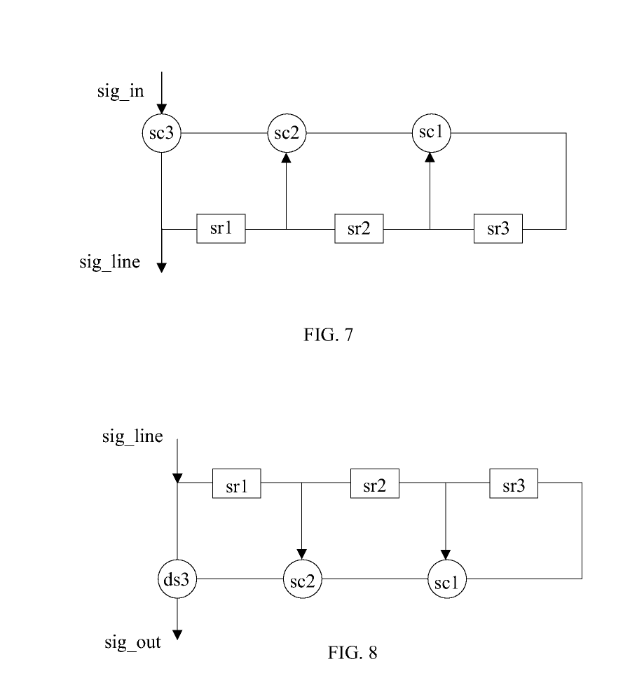

As an example of an LFSR with a non-reversible binary function, the scrambler of FIG. 7 is provided. Herein function sc3 and sc2 are the binary XOR function and function sc1 is the non-reversible NOR function. The scrambler of FIG. 7 has a corresponding descrambler as shown in diagram in FIG. 8. Herein the functions sc1, sc2 are identical to these functions in the scrambler and ds3 is identical to sc3.

As an example one may take as a binary message on input sig_in the binary message [1 1 1 1 0 0 0 0 1 0 1 0 0 1 0 1]. The initial state of the shift register is [1 0 1]. The scrambled message on sig_line is [0 1 0 1 1 1 1 1 0 0 0 1 1 0 0 0]. Inputting the scrambled message on the input of the descrambler with initial state of its shift register being [1 0 1] generates the correctly descrambled message [1 1 1 1 0 0 0 0 1 0 1 0 0 1 0 1]. Changing the initial state of the descrambler will only change at most the first three symbols of the descrambled message.

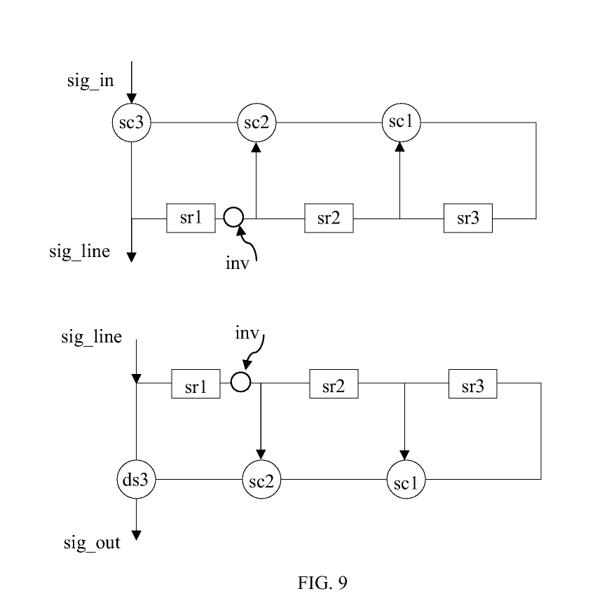

FIG. 9 shows the combination of an LFSR scrambler/descrambler wherein a binary inverter inv is inserted in the LFSR just following shift register element sr1. This may change the output signal of the LFSR, but it will not change the correct working of the scrambler/descrambler combination. In this case with input message [1 1 1 1 0 0 0 0 1 0 1 0 0 1 0 1] and initial shift register state [1 0 1] the scrambled message will be [0 0 0 0 1 0 1 0 0 1 1 1 1 0 1 1].

In accordance with a further aspect of the present invention, the messages and LFSR may be n-state such as 3-state. In an illustrative example, one can again take the scrambler of FIG. 7, wherein now sc1, sc2 and sc3 are ternary or 3-state functions and the shift register elements can retain ternary symbols or representations thereof. For instance, sc3 and sc2 may be determined by the reversible truth table

| sc3 | 0 | 1 | 2 |
|---|---|---|---|
| 0 | 0 | 1 | 2 |
| 1 | 1 | 2 | 0 |
| 2 | 2 | 0 | 1 |

Assume that sc1 is provided by the following non-reversible truth table

| sc3 | 0 | 1 | 2 |
|---|---|---|---|
| 0 | 0 | 0 | 0 |
| 1 | 0 | 1 | 1 |
| 2 | 0 | 1 | 2 |

When sig_in is the ternary message [1 1 1 2 2 2 0 0 0 0 1 2 2 1 0] and the initial state of the shift register is [0 1 2] the scrambled message outputted by the ternary scrambler of FIG. 7 will be [2 1 0 2 1 1 2 0 0 0 1 0 2 0 0]

The ternary descrambler is provided in FIG. 8 wherein ds3 is determined by the reverse of sc3

| ds3 | 0 | 1 | 2 |
|---|---|---|---|
| 0 | 0 | 2 | 1 |
| 1 | 1 | 0 | 2 |
| 2 | 2 | 1 | 0 |

It is easy to see that this descrambler will create an output message that is identical to the input message to the scrambler.

As in FIG. 9, one can provide inverters, which may be reversible or non-reversible and still have a working ternary scrambler/descrambler combination.

One may repeat the illustrative examples for n=4 wherein for instance sc2 and sc3 are the modulo-4 addition and sc1 is non-reversible provided by

| sc1 | 0 | 1 | 2 | 3 |
|---|---|---|---|---|
| 0 | 0 | 0 | 0 | 0 |
| 1 | 0 | 1 | 1 | 1 |
| 2 | 0 | 1 | 2 | 2 |
| 3 | 0 | 1 | 2 | 3 |

One can then scramble a 4-state message by the scrambler of FIG. 7 and descramble by corresponding descrambler of FIG. 8, wherein ds3 is the modulo-4 subtraction. Insertion of 4-state inverters does not influence the ability to scramble or descramble.

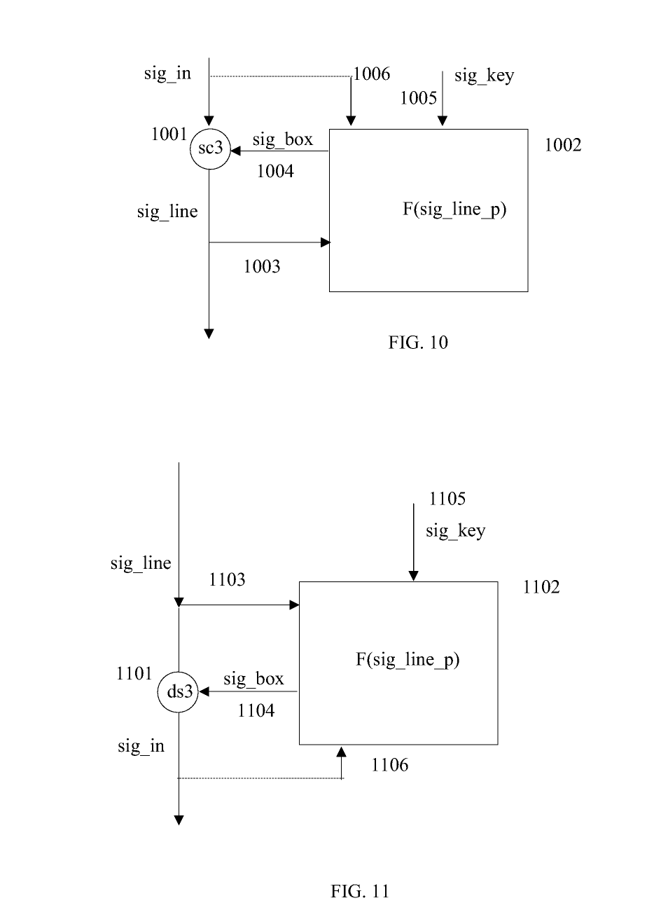

In accordance with a further aspect of the present invention a method for binary and n-state coding and decoding is provided using reversible and non-reversible functions. A principle of coding is shown in FIG. 10. A binary or n-state coder contains two units: a reversible binary or n-state switching function 1001 sc3 and a binary or n-state switching unit 1002 which may or may not be reversible. The output 1004 of 1002 provides a signal sig_box. The coded binary or n-state message is then determined by the equation sig_line=sig_in sc3 sig_box. The sig_box is generated from a previous state of sig_line which is called sig_line_p. One may also use as input to box 1002 an external binary or n-state message such as a key sig_key on input 1005 to contribute to generating sig_box. Such a key may be a sequence of n-state symbols. One may also not use a key signal. One may also use the input message sig_in on an input 1006 to contribute to generating sig_box; however one should make sure that one uses a known initial state of sig_in which should be equal to an initial state of sig_line to make the decoder work appropriately.

One can easily see, in a diagram of a binary or n-state decoder in FIG. 11, that the scrambled message can be perfectly descrambled if one knows the correct initial state of the coder. If box 1102 in FIG. 11 is identical to box 1002 in FIG. 10 and is provided with the same inputs and starts out with the same initial conditions then sig_box on 1104 is identical to sig_box on 1004. The requirement is then that function 1101 ds3 is the reverse of 1001 functions sc3, such that sig_line ds3 sig_box=sig_in.

It should be clear that the decoder can be used as a coder and the coder as a decoder.

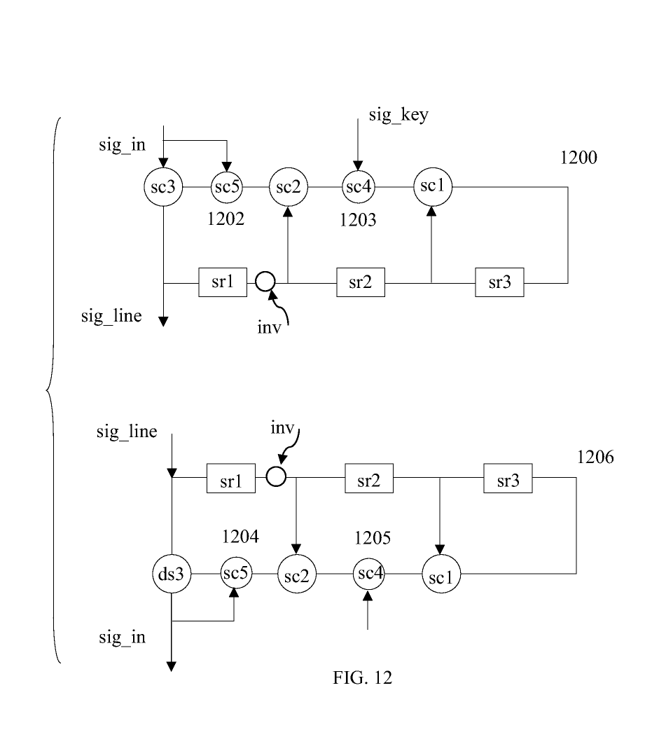

An illustrative 4-state example of a coder 1200 with a corresponding decoder 1206 is provided in FIG. 12. The coder still uses an n-state LFSR (though that is not required). The functions sc1, sc2, sc3 and ds3 are as provided earlier. The functions sc4 and sc5 are determined by the following truth tables:

| sc4 | 0 | 1 | 2 | 3 |
|---|---|---|---|---|
| 0 | 3 | 2 | 1 | 0 |
| 1 | 2 | 1 | 0 | 3 |
| 2 | 1 | 0 | 3 | 2 |
| 3 | 0 | 3 | 2 | 1 |
| sc5 | 0 | 1 | 2 | 3 |
| 0 | 0 | 3 | 2 | 1 |
| 1 | 3 | 2 | 1 | 0 |
| 2 | 2 | 1 | 0 | 3 |
| 3 | 1 | 0 | 3 | 2 |

Assume that the initial state of the shift register is [1 0 2] and that the first symbol of sig_in is always 1. Furthermore, a key is provided as sig_key=[0 1 2 3 0 1 2 3 0 1 2 3 0 1 2] and sig_in=[1 3 2 2 3 0 3 0 0 1 3 2 1 3]. This will be coded into [3 0 1 2 0 3 0 2 0 2 2 2 0 1 0]. Entering this coded message into the decoder 1206 will recover the original message. For illustrative purposes, sc4 and sc5 are selected as being reversible, however that is not required. Furthermore, one should take care of synchronization of all signals including the key and the shift register content. The here provided approach as an aspect of the current invention works for all appropriate binary or n-state switching functions and different lengths of the shift registers.

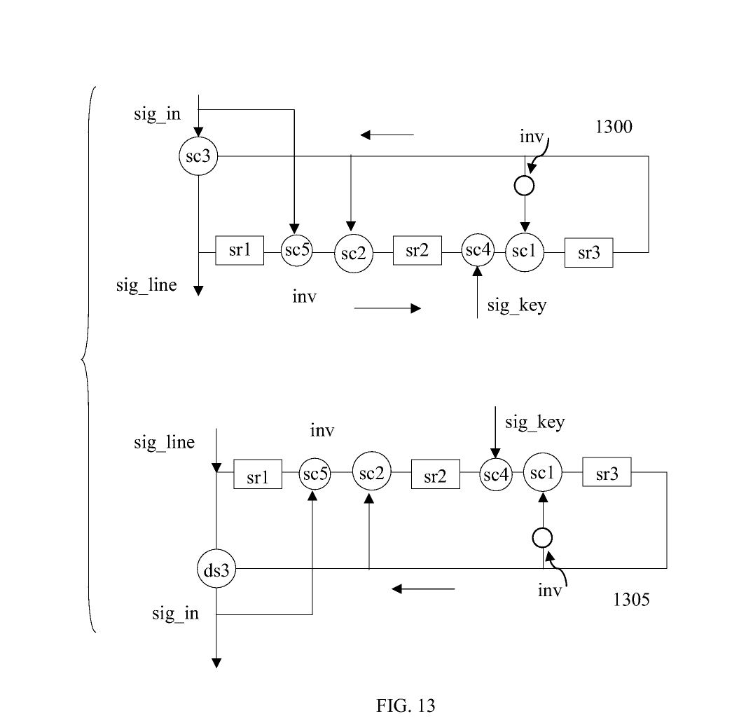

FIG. 13 provides an illustrative example of a 4-state or 4-valued LFSR in Galois configuration realizing a diagram of FIG. 10. All functions used in the identical coder box or LFSR 1300 and 1305 are identical to the ones used in FIG. 10. The LFSR herein is in Galois configuration. Assuming an initial state of the LFSR of [1 0 2] and inverter [1 2 3 0]; an initial state of sig_in=1; a key [0 1 2 3 0 1 2 3 0 1 2 3 0 1 2] and a 4-state message sig_in=[(1) 2 3 0 1 0 1 3 3 0 1 1 2 1 2] will create sig_line=[0 1 1 1 1 3 1 2 0 2 3 1 1 3]. Sig_line has one symbol less than sig_in, as the first symbol is an initial state. Inputting sig_line into the decoder of FIG. 13 with box or Galois LFSR 1305 and with the correct initial settings will generate again sig_in as decoded 4-state message. This demonstrating that aspects of the present inventions apply to LFSRs in Galois as well as Fibonacci configuration.

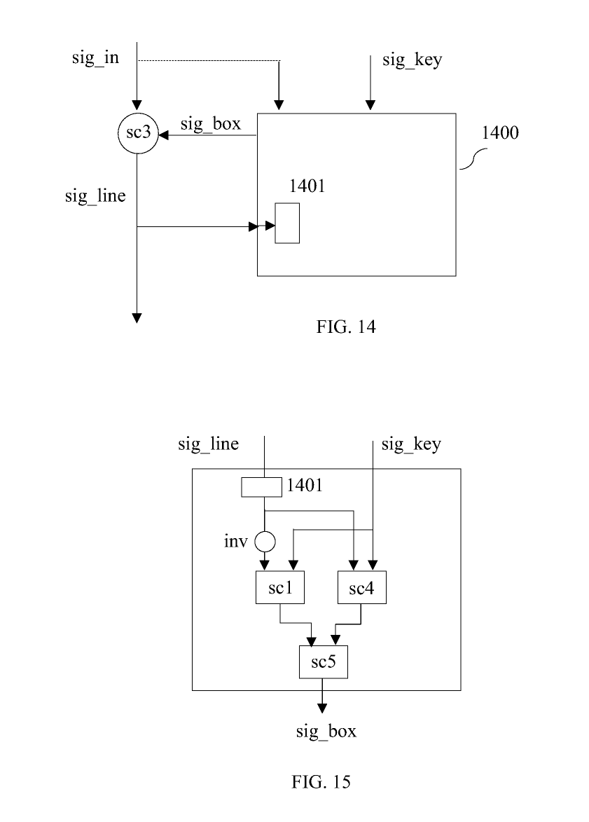

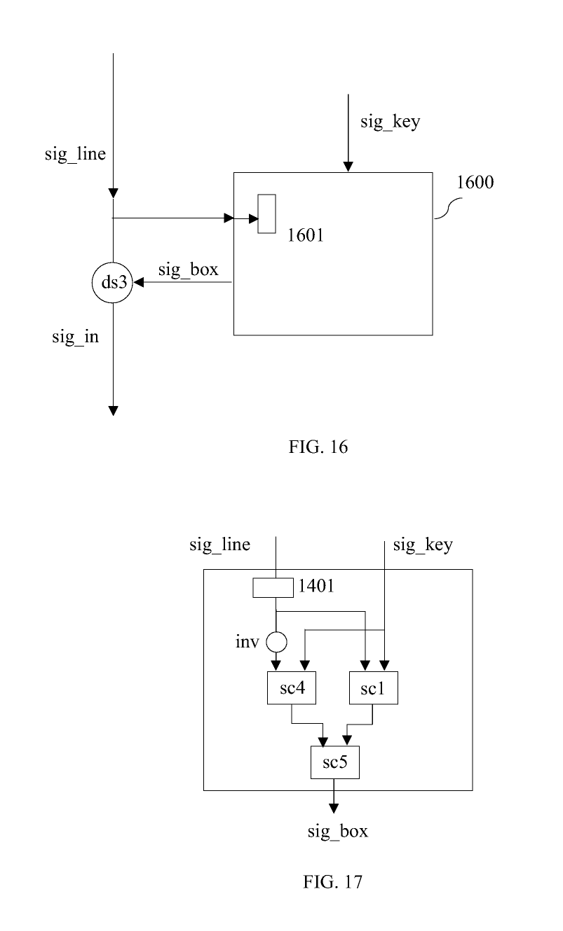

One may also apply the coder box 1002, as shown in FIG. 10, using one or more memory elements 1401 and combinational circuits or logic. An example is shown in FIG. 14 with details in FIG. 15. Because the use of sig_line creates a feedback loop it is required to retain a previous state of sig_line and an initial state when a coder or a decoder starts. The functions used in the coder box are the earlier used 4-valued functions as an illustrative example. The corresponding decoder with one or more memory elements 1601 is shown in FIG. 16. It should be clear that coder box 1400 in the coder and 1600 in the decoder are identical if coder and decoder are corresponding devices or programs.

One can also use as an input signal for creating a sig_box the input signal sig_in to the coding box 1400 and 1600. One may retain earlier values or states of sig_in in determining sig_box. The decoder box 1600 is almost identical to 1400 when one uses sig_in. To initialize 1400 one may use a first element of sig_in and a first key signal. The decoder requires a memory element to provide an initial state.

As a further aspect of the present invention, one may use the LFSR and other coders having a reversible scrambling function to change the statistical make-up of a coded message. For instance one may input the 4-valued coder with a binary message [1 1 0 0 1 0 1 0 0 0 1 1 0 1 0] making sure to use the correct representation at a physical input and code the binary message into [3 0 2 2 2 1 0 3 1 0 0 0 0 3 3]. Such a ‘higher state coding’ makes cryptanalysis of a message much harder.

The illustrative examples herein provided apply LFSRs in Fibonacci configuration. Use of n-state LFSRs in Galois configuration that use reversible and/or non-reversible n-state or binary switching functions are fully contemplated.

The herein provided methods and apparatus can be implemented in general processors sing memory wherein instructions can be stored and executed. Dedicated processors and circuitry to execute the methods which are an aspect of the present invention can also be used. If one uses physical signals wherein one symbol is represented by a single signal element which may assume one of 2 or more states then one can still perform the methods which are an aspect of the present invention by using A/D converters to create binary signals and D/A converters to create again n-state signals.

In the illustrative examples shift registers are provided of which the shift register element can contain a binary or an n-state with n>2 symbol or a representation of an n-state symbol. The examples show a shift register of 3 shift register elements. It is to be understood that this is for illustrative purposes only and that a shift register may have one or more shift register elements.

It should be clear that many of the decoder configurations herein provided in accordance with an aspect of the present invention may be self synchronizing. That means that if an error has occurred during transmission the decoding may provide an incorrectly decoded signal. However, after one or more errors have been flushed from the system, the decoder starts to decode correctly. Some decoders with LFSRs in Galois configuration may not be self-synchronizing. The applicant has shown in earlier cited patent application Ser. No. 11/696,261 how to realize self-synchronizing descramblers with LFSRs in self-synchronizing mode.

It should be clear that the coder box can come in many different forms: with or without LFSR, dependent only on forward provided messages or keys or with feedback. With combinational circuits and with sequential circuits which contain one or more memory element. All these circuits can easily be modified in a programmable sense to make them generate different output signals even when the same input signals are provided. For instance, one can change the functions, or for instance, change the taps of an LFSR. One may make those changes while leaving all the contents of memory elements the same, so no special initialization is required. One may change settings once or many times, for instance, depending how many symbols have been processed already. It should be clear that such a change should take place for the coder box in the coder as well as the decoder at corresponding moments.

For instance, the coder of FIG. 15 may be programmed to change after 8 symbols to the coder of FIG. 17. This may be very easy in a coder which is operated as a program on a processor. A similar change has to take place of course in the decoder. Such a change may make cryptanalysis of a message much more difficult. Certainly such changes are fairly easy to manage in coders and decoders. Especially in n-state coders and decoders the available amount of different configurations is significant.

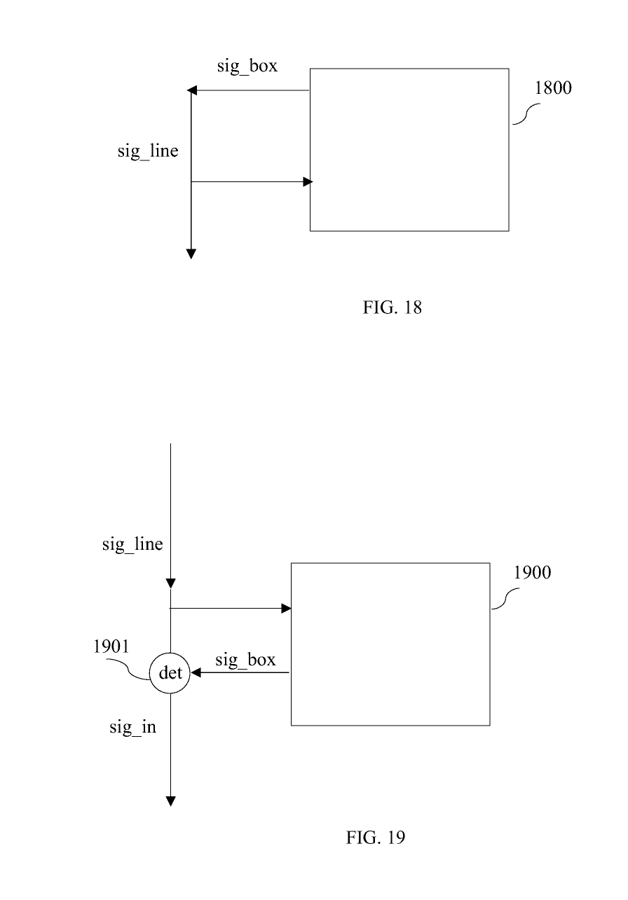

As a further aspect of the present invention, an n-state coder with an n-state LFSR containing at least one non-reversible n-state function can be used to generate a sequence of n-state symbols. This is shown in FIG. 18. While a sequence generator with an LFSR with reversible functions is known, using at least one n-state non-reversible function is novel. A sequence generator is shown in FIG. 18 wherein a coder box 1800 will contain said LFSR. One may include further circuitry such as combinational circuits to generate a sequence which is outputted as sig_line. The diagram as shown in FIG. 18 as before works under a clock or control signal which is assumed but not shown. The sequence which is outputted by the coder of FIG. 18 is further determined by the initial state of the coder box 1800.

One may detect the sequence generated by the generator of FIG. 18 by the decoder of FIG. 19. The coder box 1900 is identical to 1800. The function ‘det’ should have a truth table that allows detection of sig_line. As shown by the applicant in, for instance, United States Patent Pub. No. 2005/0184888 A1, dated Aug. 25, 2005, which is incorporated herein by reference, one can detect a sequence generated by an LFSR by using a descrambler with the same LFSR applying a special detecting function. The ability to detect a sequence originates in the fact that when the LFSR of the detecting descrambler has the same initial state as the generator the input sequence to the LFSR will be identical to the output of the LFSR. In terms of the diagram of FIG. 19 that means that when 1800 is identical to 1900 and sig_line inputted to the coder of FIG. 18 is identical to the decoder of FIG. 19 (including the initial states) then sig_box in FIG. 19 is identical to sig_line. One can then use a function ‘det’ which has a truth tables that provides a first state when sig_line is identical to sig_box and not a first state when sig_line is not equal to sig_box. A 4-valued example is for instance

| det | 0 | 1 | 2 | 3 |
|---|---|---|---|---|
| 0 | 1 | 0 | 0 | 0 |
| 1 | 0 | 1 | 0 | 0 |
| 2 | 0 | 0 | 1 | 0 |
| 3 | 0 | 0 | 0 | 1 |

For instance, a 4-state sequence of 31 symbols will be detected if 31 consecutive states one are generated. One may take into account potential line errors and synchronization errors and set the level of detected at for instance 24 ones.

An LFSR based coding/decoding system can be used as a continuous or streaming mode. This means that every time a new symbol, or a representation of a symbol is provided at an input a coded or scrambled symbol or its representation can be generated. The same applies for the coder and decoder of which an example is shown in FIG. 10 and FIG. 11. All coders and decoders can also be operated in word mode or as a block coder which is explicitly contemplated. For instance, one can run a coder on a word that consists of the same number of n-state symbols as the number of shift register elements. Once a word is coded a new word, which preferably does not overlap with a previous word, can then be coded. This may prevent a perpetuation of errors for instance.

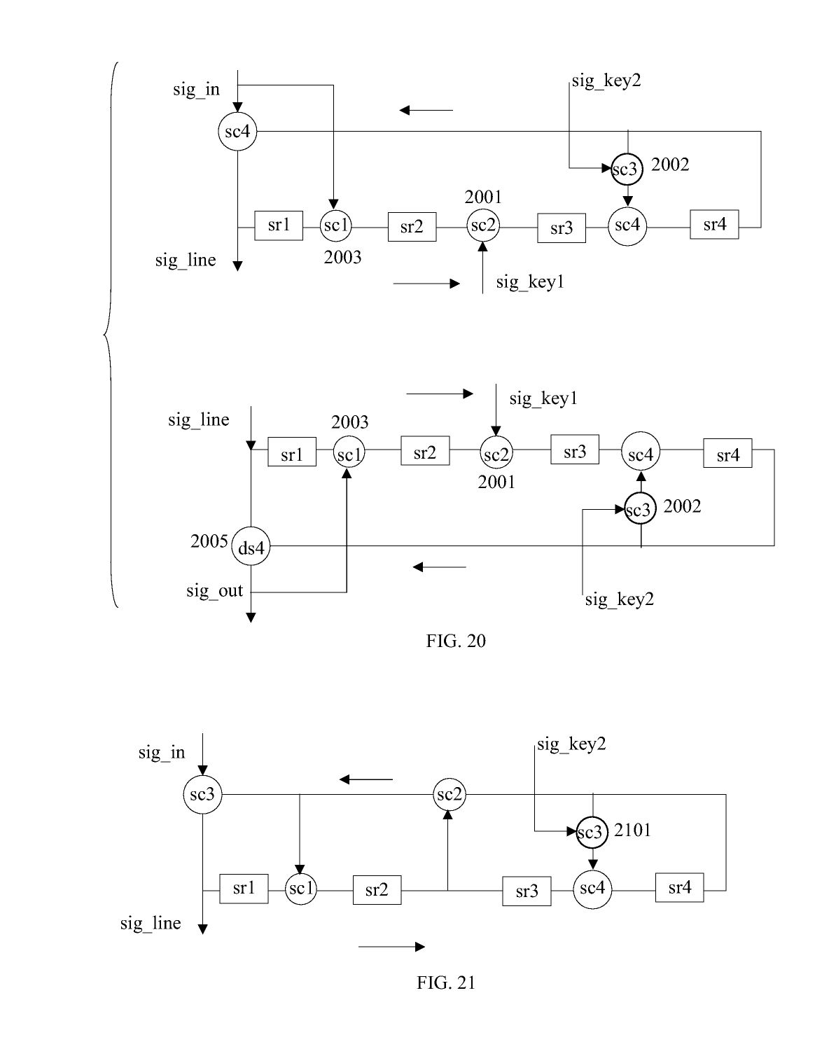

FIG. 20 shows another implementation of a scrambler/descrambler combination with an LFSR in Galois configuration. The Linear Feedback Shift Register is in fact a novel LFSR. An external signal such as sig_key1 and sig_key2 are applied to devices in the LFSR implementing sc2 in device 2001 and sc3 in device 2002 to make sure that a descrambler only descrambles when a synchronized key signal is applied. Furthermore, in the scrambler the input signal to the scrambler, which is external to the LFSR, is inputted on device 2003 implementing function sc1. In the descrambler it is the descrambler output signal that is provided to an input of device 2003.

As long as all signals in scrambler and descrambler (including the initial state of the shift register are synchronized) the descrambler will correctly descramble the scrambled signal. The LFSR as disclosed herein is a novel LFSR, because it is controlled externally by receiving on an input of one of its devices implementing a 2-place 2-state functions a signal that is external to the LFSR.

In the configuration of FIG. 20 one has to make sure that the shift registers of scrambler and descrambler are identical at corresponding moments for correct descrambling. One may apply the principles of synchronized key signals also to self-synchronizing Galois and Fibonacci LFSR configurations. For instance, one may run a scrambler/descrambler in what may be called a public mode by defining a key signal as for instance all 1s. One may apply the scrambler/descrambler combination in a non-public or confidential mode by applying one or more confidential key signals.

The scrambler in FIG. 20 shows how an incoming and to the sender known signal sig_in is used to control a device 2003 implementing a 2-place function sc1 by putting the signal on one of its inputs. It should be clear that such a use of an input signal is only possible if a device implementing sc1 is positioned after a memory element, for the scrambler to have a corresponding descrambler. In case no shift memory element is used between the device 2005 implementing the 2-place function ds4 which is the reverse of sc4 and the device 2003 implementing sc1 feedback instability may occur.

FIG. 21 shows a scrambler in a combined Galois/Fibonacci mode, wherein a device 2101 implementing a 2-place function sc3 is provided on one input with an external key signal.

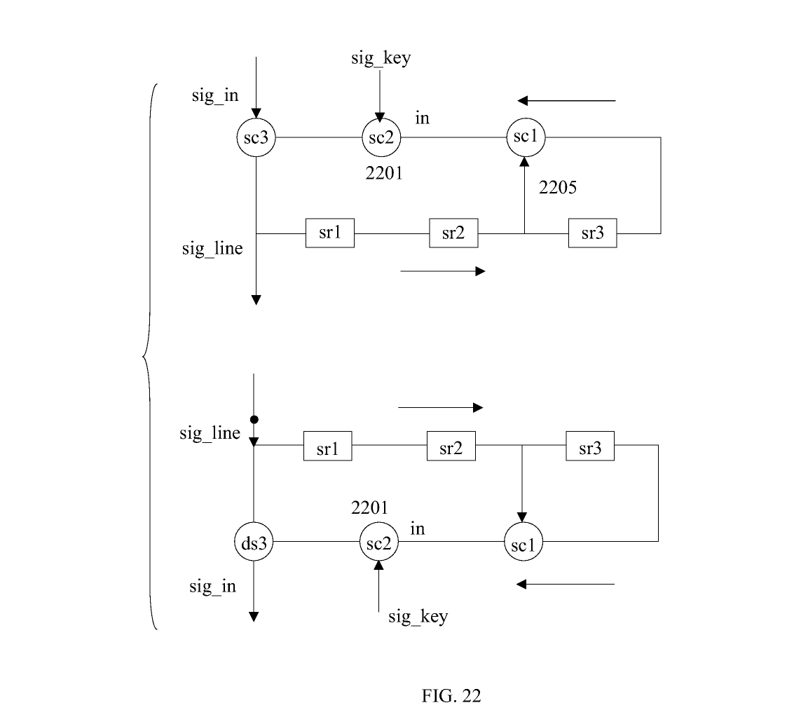

FIG. 22 shows a scrambler/descrambler combination in Fibonacci configuration. herein a device 2201 implements a 2-place function 2201 which receives an external signal key_sig on an input. By making sure that the signal key_signal at scrambler and descrambler side are synchronized one has this created a synchronizable scrambler/descrambler combination.

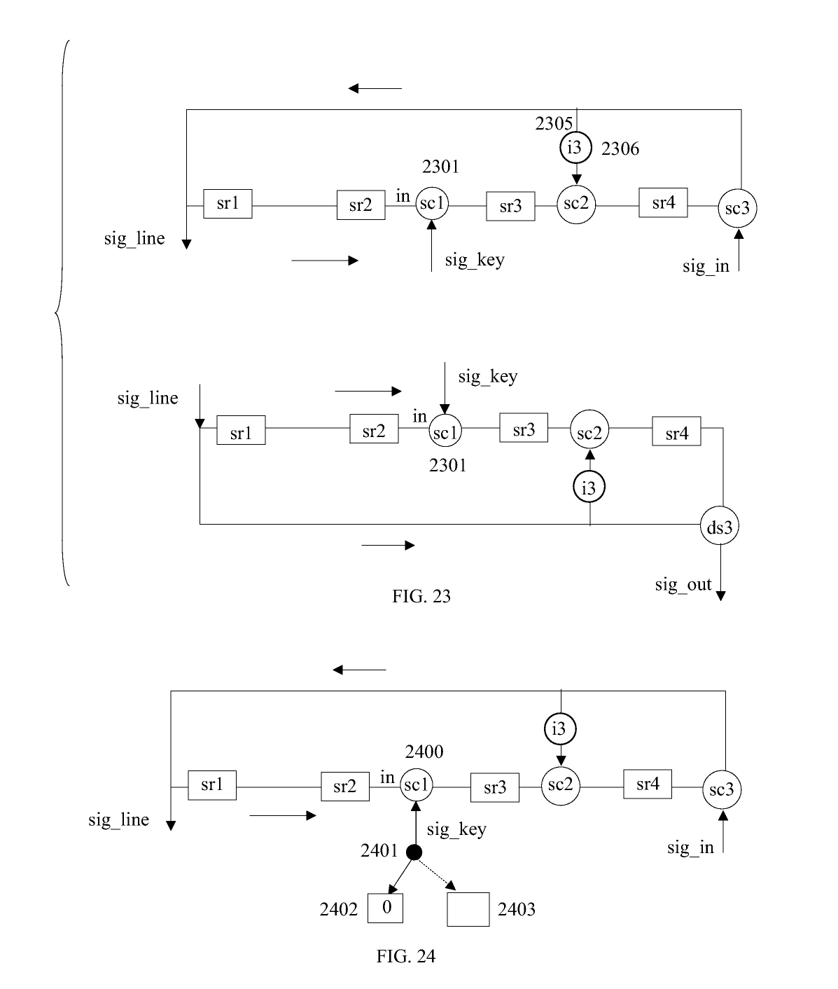

FIG. 23 shows a scrambler/descrambler combination in Galois configuration. The descrambler in FIGS. 22 and 23 are both self-synchronizing. This means that errors that have occurred during signal transmission will not propagate but will be flushed from the LFSR. The scramblers/descramblers also have an external signal called sig_key that is provided on an input of a device implementing n-state logic function sc1. In the case of FIG. 23 the device 2301 implements a 2-place n-state functions sc1. In all cases n may be 2 so that all signals and circuits are binary.

An example is provided to illustrate different flushing effects. Assume that the scrambler and descrambler of FIG. 23 are binary and that sc1, sc2 and sc3 are binary XOR functions and i3 is [0 1] or the Identity Inverter. Further assume that the initial shift register content is [1 0 0 1]. A signal representing sig_in=[0 1 1 0 1 0 1 1 0 1 1 1 0 0 1 0] is provided on the input of the scrambler. A key signal representing sig_key=[0 0 1 1 0 0 1 1 0 0 1 1 0 0 1 1] is provided on input sig_key. The scrambler generates an output signal representing sig_line=[1 0 1 0 1 0 0 1 1 1 0 0 0 0 1 1] is provided on the output of the scrambler.

The signal sig_line is provided on the input of the descrambler. If the initial state of the mLFSR is identical of the scrambler at the start of scrambling and the signal sig_key is synchronized correctly then the descrambler will provide the correctly descrambled signal. An error in the signal sig_line will be flushed. An error in the signal sig_key will also be flushed. For instance, assume that an error occurred at bit 7 and 8 of sig_key and that sig_key is now sig_key=[0 0 1 1 0 0 0 0 0 0 1 1 0 0 1 1]. The signal at the output of the descrambler will then represent [0 1 1 0 1 0 1 1 1 0 1 1 0 0 1 0]. The two bits descrambled in error are marked in the sequence. This demonstrates that key errors will also be flushed in the descrambler.

One may try to use a different key signal in the descrambler. For instance, one may shift each bit in the key sequence in the descrambler with exactly one position. This will generate in the above example as output the sequence [0 1 1 1 1 1 1 0 0 0 1 0 0 1 1 1]. One can see that errors in the key signals (or using the wrong key signal) will create an incorrectly descrambled signal.

One can easily provide non-binary examples such as 3-state or 4-state examples, for instance in FIG. 23. One may select sc1, c2 sc3 and ds3 to be an adder over GF(4), which is a self-reversing function. One may select device 2306 which implements inverter i3 to be a 4-state reversible inverter [2 3 0 1]. The signal sig_in may be a sequence of 4-state symbols, and the signal key_in may also be a sequence of 4-state symbols. It is noted that the number of to be scrambled symbols or signals can be greater than the number of shift-register elements of the LFSR of the scrambler. This applies for all LFSR based scramblers that are provided herein as one or more aspects of the present invention. One may scramble and descramble in a continuous or streaming mode, without resetting an initial state of an LFSR. If one so desires, one may also start scrambling from a predetermined initial LFSR state and process a fixed number of symbols, after which one may reset the LFSR to an initial state. One may call this a word or a block mode. One may do this resetting for scrambling/descrambling for a number of symbols that is smaller, equal or greater than the number of shift register elements in an LFSR.

It is pointed out that the LFSRs as provided herein can run in a continuous or streaming fashion or in a block mode.

N may also be greater than two. In that case, all circuits and signals may be n-state. However, all circuits and signals may also be binary, but able to process words of p bits so that all signals represent an n-state symbol and all circuits can process signals representing an n-state symbol.

The descramblers in FIGS. 22 and 23 flush errors that occur in sig_line or in sig_key. The inclusion of a circuit in the self-synchronizing LFSR that acts on an external signal, allows the scrambler/descrambler to operate in two modes: in a public self-synchronizing mode and in a non-public or confidential, self-synchronizing mode. When the LFSRs of FIGS. 22 and 23 are binary LFSRs the function sc1 may be for instance an XOR function. In the public mode the signal sig_key may be a signal representing state 0. The following truth table illustrates the effect of such a constant signal.

sig_key

| | sc1 | 0 | 1 |
|---|---|---|---|
| in | 0 | 0 | 1 |
| | 1 | 1 | 0 |

If sig_key=0 then the output of the function sc1 will be equal to the input state of input signal ‘in’. In that case it appears as if ‘sc1’ is replaced by a direct connection. The scramblers/descramblers act as if it is a public self-synchronizing descrambler. In case the initial state of the LFSR is not known, the shift register will be flushed and the descrambler will start providing correctly descrambled signals.

One may also put a variable external binary signal on the input of sc1 as sig_key in a scrambler. In that case one will need to provide exactly the same signal key_sig (and in-phase with sig_key at the scrambler) to correctly descramble the scrambled signal with the self-synchronizing descrambler. The advantage is that this system provides increased security and in-phase operational properties. Often, one may apply error-correcting codes, which allows correction of a limited number of transmission errors. In the case of a limited number of errors, it may be beneficial to have the ability to continue descrambling and error correct, rather than request resending data, which is sometimes not possible, if a descrambler propagates errors.

The concept of switching between public and confidential mode is illustrated in a scrambler FIG. 24. The input to the device 2400 implementing 2-place function ‘sc1’ is connected by a switch 2601 to either a constant source 2602, providing, for instance, constant state 0, and a source 2603 which provides a sequence of varying signals. Source 2603 may for instance be a Pseudo-random noise (PN) sequence generator. One would use the same set-up in a descrambler. The PN sequence generators between scramblers and descramblers may be permanently synchronized. Setting the switch 2601 from 2602 to 2603 then changes from public to confidential mode. One may include in a pre-amble of a message a code that sets a switch 2601. In the illustrative example the selection is limited between two sources of a key signal. It should be clear that a switch may switch between more than two sources and that other sources for key signals may be applied.

It should also be clear that other binary logic functions for function sc1 may be applied. The following table shows several truth tables that can be assigned to a function sc1.

| | |
|---|---|
| sig_key | sig_key |

| | = | 0 | 1 | | AND | 0 | 1 |
|---|---|---|---|---|---|---|---|
| in | 0 | 1 | 0 | in | 0 | 0 | 0 |
| | 1 | 0 | 1 | | 1 | 0 | 1 |

If one uses for ‘sc1’ the ‘=’ function with constant source ‘0’ for sig_key, then the output of ‘sc1’ is the inverted state of ‘in’. If one uses a non-reversible function such as the AND function, then sig_key has to be constant ‘1’ to act as passing on the state of ‘in’.

The structure as provided in FIGS. 20-24 can also be applied to n-state implementations. For instance the function ‘sc1’ in FIG. 24 can be the 4-state function as provided by the following truth table.

sig_key

| | sc1 | 0 | 1 | 2 | 3 |
|---|---|---|---|---|---|
| | 0 | 0 | 1 | 2 | 3 |
| in | 1 | 1 | 0 | 3 | 2 |
| | 2 | 2 | 3 | 0 | 1 |
| | 3 | 3 | 2 | 1 | 0 |

When sig_key provides a constant state ‘0’, then the output of ‘sc1’ is identical to the state of ‘in’. One may also provide sig_key with a different constant source. Or one may provide sig_key with a source that changes states, such as a 4-state Pseudo-random Noise (PN) sequence. The inventor has disclosed these and other n-state PN type sequences in for instance U.S. Patent Pub. No. 2005/0185796 A1, dated Aug. 25, 2005, and U.S. Patent Pub. No. 2005/0184888 A1, dated Aug. 25, 2005, both of which are incorporated herein by reference in their entirety. One may use for ‘sc1’ also a non-reversible n-state function.

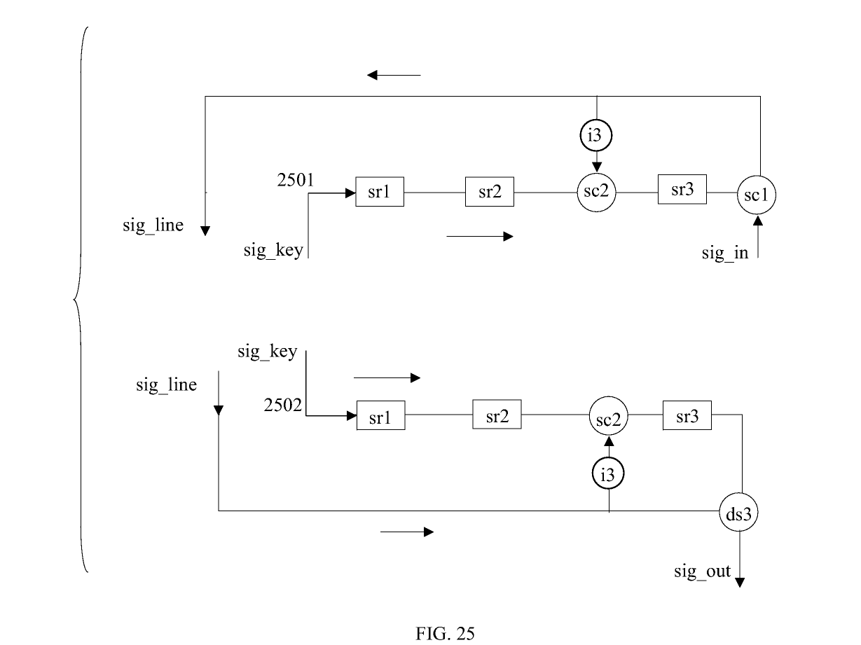

FIG. 25 shows another embodiment of the present invention to modify an LFSR. One may ‘cut’ connecting elements in an LFSR and insert an external signal sig_key. In FIG. 25 this cut takes place at shift register element sr1, where the signal sig_key is inserted. That means that the complete feedback loop is shortened. At insert 2501 at sr1 in the scrambler and 2502 at the descrambler an external signal is injected into the shift register element sr1. There still is feedback through inverter i3 through the device implementing sc2 in the scrambler. This demonstrates another modified LFSR.

As an aspect of the present invention modified Linear Feedback Shift Registers (mLFSRs) have been introduced. An mLFSR may be an LFSR wherein either at least one device implementing a 2-place n-state switching function having at least 2-inputs and one output that is determined by a truth table of at least dimension n by n with n≧2, or with n>2, is a non-reversible n-state function, or/and at least one device implementing a 2-place function is controlled by a signal on one of its inputs external to the LFSR and/or an external n-state signal is directly injected into the LFSR after the LFSR loop was cut or interrupted. The mLFSR can be applied in any LFSR application. It can for instance be applied in a scrambler and a descrambler device. It is clear that an mLFSR can also be applied in a sequence generator and in a sequence detector.

Next some illustrative examples will be provided of mLFSRs in sequence generators. FIG. 26 shows an n-state sequence generator. A clock signal herein is assumed but is not shown. The generator 2600 has a shift register of 5 shift register elements of which 2605 is identified. The generator is in Fibonacci configuration. However, the aspects of the present invention related to mLFSRs in sequence generators also apply to Galois and Fibonacci/Galois configurations. The sequence generator 2600 has a tap 2607 with an n-state inverter 2602. The return connection from the last shift register element also has an n-state inverter 2603. The return connection and the tap 2607 are connected to the inputs of a device 2601 which implements an n-state 2-place function. It is to be understood that n can be 2. In that case, the sequence generator is a binary sequence generator. Usually, binary inverters 2602 and 2603 are not shown as they usually are the Identity Inverters or straight through connection. In the binary case, 2601 can be the XOR or the Equivalence function. When n>2, then 2601 can be any reversible n-state function and the inverters are in general any reversible n-state inverters. In an mLFSR 2601 can also implement a non-reversible n-state function or non-reversible inverters. This may adversely affect correlation properties of the binary or n-state sequence that is generated on the output 2604.

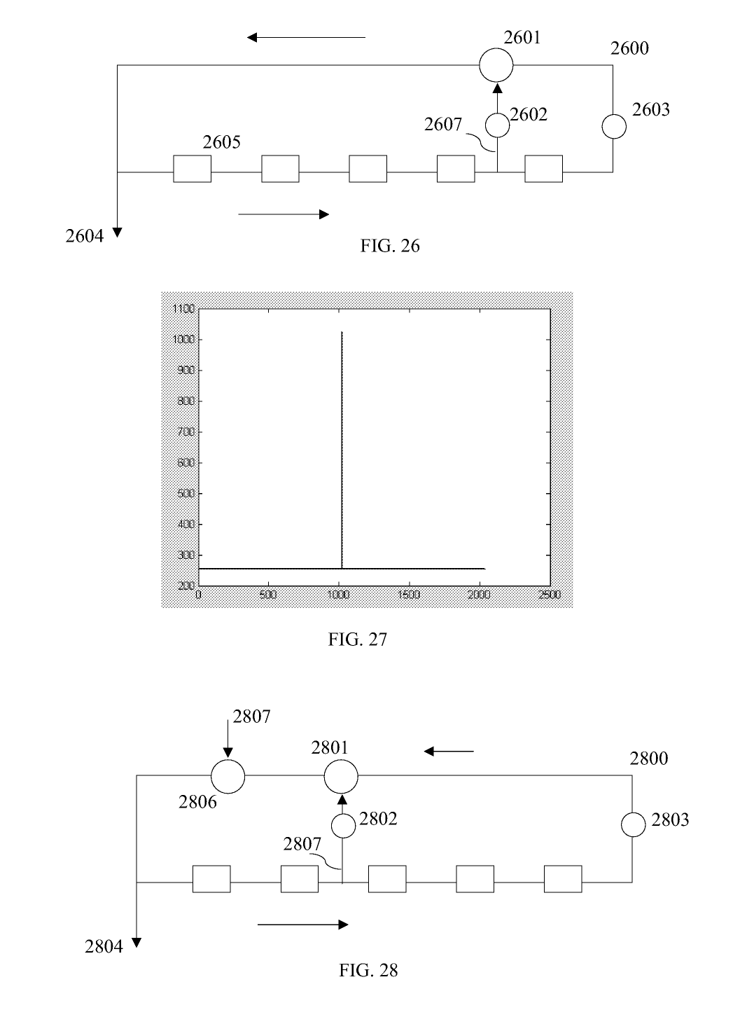

For instance, one may implement a 4-state sequence generator with 2601 implementing an adder over GF(4), inverter 2602 is the 4-state inverter [3 1 0 2] and the inverter 2603 is the 4-state inverter [0 2 3 1]. The maximum length pseudo-random noise (PN) sequence is a 1023 symbols 4-state sequence. Herein, each symbol is or may be represented by a 4-state signal. FIG. 27 shows the auto-correlation of the 4-state PN sequence. The correlation is determined by comparing a symbol with a reference symbol. If symbols or signals are identical, then a fixed value (for instance 1) is added to a sum. When symbols or signals are not identical the sum remains unchanged. One may also subtract a number if symbols or signals are not identical. One can see that using this correlation method provides a single peak of 1023 in aligned auto-correlation.

This way of calculating a correlation is easier on recognizing PN sequences. It shows a single peak. The classical auto-correlation (or cross correlation) of course apply the value or an assigned value to each signal. This leads to the classical definition

$${R}_{xx} ( i ) = {\sum }_{j = 0}^{N - 1} {a}_{j} {a}_{j + i} .$$

The classical definition is useful if one adds different sequences to a noise like signal. If one needs to distinguish for instance between two sequences, the comparison is easier to use.

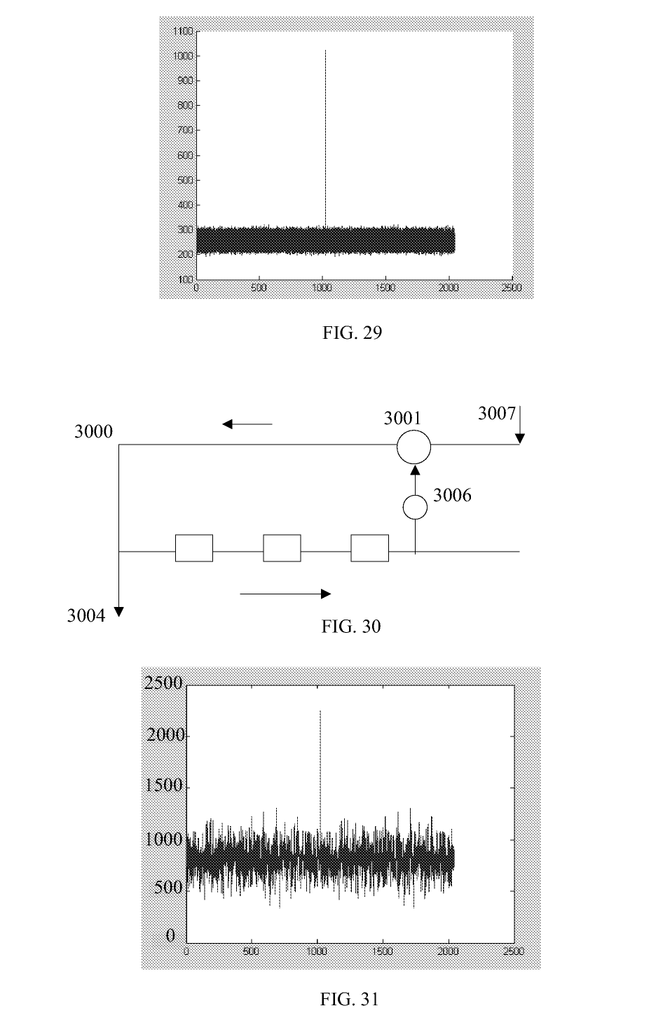

In general, different uses of functions 2601 and inverters 2602 and 2603 from the selected ones in the example will create generators that will not generate PN-sequences. However, one may modify the LFSR of FIG. 26 to the mLFSR as shown in FIG. 28. Herein, a device 2806 implementing a 4-state function such as a modulo-4 addition is used with on input 2807 a PN sequence of which the auto-correlation was shown in FIG. 27. The different sequence generators 2800 created by using different inverters 2803 and 2802 in tap 2807 may create different sequences which are provided on output 2804. These different sequences may create a combined auto-correlation/cross-correlation graph as shown in FIG. 29, according to a correlation method by comparison as shown before.

One may also create mLFSRs as shown in FIG. 30. The LFSR 3000 is shortened to 3 shift register elements. One device 3001 implementing a 4-state function and with an inverter 3006 at one input is provided with the PN sequence on the input 3007. A sequence is provided on output 3004. The combined auto-correlation/cross-correlation graph of the different sequences depending on the inverter 3006 is shown in FIG. 31.

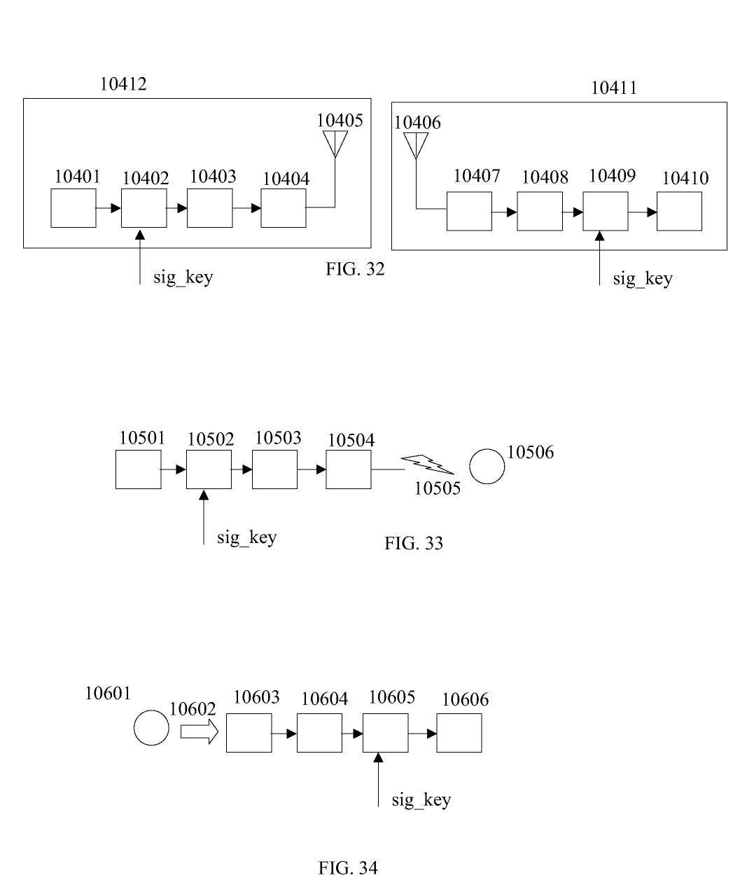

A diagram of a communication system is shown in FIG. 32. A source 10401 generates a signal, which may be converted in n-state symbols or signal representation thereof, having one of n discrete states with n greater than 2. The source may also provide binary signals, with or without word synchronization. The signal from 10401 may be converted into words of binary symbols or signals representing those symbols or they may be binary signals with no word synchronization. The signal source 10401 may be other equipment or systems, for instance, multiplexing equipment or other equipment. The signals may be scrambled in accordance with an aspect of the present invention in scrambling unit 10402. This unit may receive a signal sig_key that is external to the LFSR of the scrambler in accordance with an aspect of the present invention for providing a key signal to the scrambler. This unit may also provide line-coding facilities. A unit 10403 may provide additional error control coding, including error correction or error detection. Line coding may take place in its entirety in unit 10403 instead of 10402 or partially. It is known that multiple coding schemes may be applied. Unit 10402 or 10403 may also provide signal interleaving. The signal in scrambled and coded form may then be provided to a transmitter 10404 which may provide further signal conversion, modulation, signal shaping, including amplification and transmission medium matching. It is then provided to a medium converter such as an antenna 10405. At the receiving end the process is reversed. A receiving transducer 10406, which may be an antenna, receives a signal; the signal may be optimized, amplified, demodulated, detected, and converted into signals that are further processed by a unit 10407. Unit 10408 may provide error detection or correction, which may be combined with de-interleaving. Unit 10409 may provide detection or descrambling of a sequence in accordance with an aspect of the present invention. This may include using a key decoding signal key_sig that is external to the LFSR of the descrambler in accordance with an aspect of the present invention. Unit 10410 may be the target of the system. This may be an end user such as a receiving phone or tv set or computer. It may also be an apparatus that is part of a communication system, such as a demultiplexer or any other communication or storage apparatus.

It is to be understood that additional functions may be included in a system as shown in FIG. 32. It may include additional coding steps, insertion of pilot tones or any other useful step. However, these steps in general will not negate the step of scrambling, descrambling or sequence detection as provided herein as different aspects of the present invention. Unit 10411 may be a communication device that can receive and that can process a signal in accordance with at least one aspect of the present invention. Such a device may be a tv-receiver, a computer that is connected to a network for instance the Internet, a mobile computing device, a wireless computing device, a radio device, a wireless phone, a GPS device, or any device that can receive a signal that can be processed in accordance with at least one aspect of the present invention. The scrambling, descrambling and sequence detection methods and apparatus that are an aspect of the present invention may also be applied to a data storage system. Such a system in general contains two parts a writing part which is shown in diagram in FIG. 33 and a reading part which is shown in diagram in FIG. 28.

The writing part of a storage system as shown in FIG. 33 has units that provide several functions. A unit 10501 provides digital data. This may be data in the form of discrete n-state signals. It may also be data in the form of binary signals. The signal may be binary or non-binary signals with no word synchronization. A unit 10502 may scramble the signal as provided by 10501 in accordance with one or more aspects of the present invention. A signal external to the LFSR of the scrambler sig_key may be applied in accordance with an aspect of the present invention. A unit 10503 may provide error control coding. A unit 10504 may provide signal conversion and/or shaping and/or modulation to prepare the signal for writing to a storage medium 10506. The signal as generated by 10504 may be provided to a signal converter 10505 that converts the signal from 10504 to a signal that can be written to a medium 10506 and may include a Digital/Analog converter. For instance, 10504 may be an electrical signal that is converted to an optical signal by 10505 to be written to a storage medium that is an optical disk 10506. A storage medium 10506 may be an optical, electro-optical, magneto-optical, magnetic or electronic medium or any medium that can store binary signals and/or non-binary signals.

A storage system also has a reading part as shown in FIG. 34. Herein, a signal is read from the medium 10601 by a transducer 10602 and processed by 10603, which may include a demodulator, an Analog/Digital transducer or other processing components. A unit 10604 may provide error correcting decoding or error detection, de-interleaving and the like. A unit 10605 may provide descrambling and/or sequence detection in accordance with an aspect of the present invention. A signal sig_key external to the LFSR of the descrambler may be applied in accordance with an aspect of the present invention. The target for the detected and/or descrambled signal is unit 10606. The order of units and functions may in some instances be in a different order. Other functions may also be provided, including insertion and/or detection and/or removal of synchronization data. The device as shown in FIG. 34 may be part of a storage device that is a CD-player, a DVD-player, an MP3 player or any device that is enabled to read and play a signal that can be processed in accordance with at least one aspect of the present invention.

The device 10411 in FIG. 32 and the device as shown in diagram in FIG. 34 may both be called a playing device that processes a signal according to at least one aspect of the present invention.

Scramblers and descramblers as provided herein may be applied to storage devices. For instance, one may scramble a word of p-bits before writing it to a magnetic storage disk, an optical storage disk or to an electronic storage device. One may transfer a word of p-bits into a single 2^{p} symbol. One may modulate the signal with a modulation technique such as QAM-2^{p} before writing it to a storage medium. One may reverse the operations for retrieving 2^{p} symbols or p-bit words from a storage medium: read the symbols from the medium, if required demodulate the read signals, and descramble the symbols or words with the descramblers herein provided. One may also use sequence generators provided herein on storage media, for instance for synchronization purposes. An n-state sequence or a sequence of p-bit words may indicate a point of significance on the storage medium. Either the provided correlation techniques or sequence detectors may be applied to find those points of significance. Accordingly, communication systems and apparatus and data storage apparatus and systems using the scramblers, descramblers, sequence generators and sequence detectors have also been provided as an aspect of the present invention.

One may also store QAM signals on an optical disk. By using a signal writer such as a light source and a light pick-up as for reading the receiving antenna one may write a signal to an optical disk and read the n-state optical signal from the disk. Accordingly a storage system is provided that can apply the scrambling and descrambling methods provided herein. Optical herein includes purely optical, as well as electro-optical and magneto-optical as well as any other phenomenon that has an optical component. Data storage systems and apparatus may also use magnetic materials. Such devices may, for instance, store directly multi-state symbols with for instance different magnetic states or orientations. They may also be stored in a quasi-analog/digital manner for instance as a QAM-n modulated signal.

The scrambling and descrambling methods and apparatus, the sequence generating and detecting methods and apparatus, and the correlation methods and apparatus as provided herein as an aspect of the present invention may be part of a system. This may include: a communication system, a data storage system or any other system for coding, or transmitting, or storing, or receiving, or retrieving, or decoding or any other system for processing data. The system may be a wired or a wireless system. A data storage system may be a system using an optical disk, or an electro-optical disk. It may also use a magnetic medium. Symbols may be represented as optical, electronic or any other valid representation that can be processed, including magnetic. The n-valued symbols may be represented as signals having physical properties of, for example, different amplitude, phase, modulation, polarization or any other quantifiable physical property. Switching tables may be realized in electronic, optical, electro-optical, electro-mechanical, quantum mechanical or any other way that can implement an n-valued truth table. A symbol may also be represented by a series of lower valued symbols such as binary symbols. Switching and storage of symbols then take effect on the series of symbols, often called words.

A binary or n-state function that is an inverter may be called a one-place function. A device that implements such a function in general has only a functional input and a functional output, though it may have inputs for power supply and the like. Such one-place functions are determined by a 1 by n truth table for an n-state inverter and a 1 by 2 truth table for a binary inverter. An n-state or binary switching or logic function that can be defined by an n by m truth table with m≧n and n≧2 may be called a 2-place function as it has two inputs (and one output). It may also be called a 2-place logic function, or a 2-place n-state logic function. In the binary case such a function may be called a 2-place binary logic function. XOR and EQUIVALENCE are both reversible binary 2-place functions.

A connection between two connection points herein may be a straight connection. One may also say the connection is formed by an Identity Inverter or an Identity one-place logic function; for instance in the binary case [0 1]→[0 1]. A connection is herein also considered to be a connection that includes a reversible one-place function that is not an Identity Inverter; for instance in the binary case [0 1]→[1 0] is considered herein a connection. In a connection in the n-state case with n>2 wherein the one-place logic function in a connection is not reversible, but does not provide one constant output, is also considered to be a connection. A one-place logic function that provides one constant output, for instance [0 1]→[0 0] is not considered to be a connection. For instance, in FIG. 22 tap 2205 which has no inverter and connects two points is a connection herein. In FIG. 23 tap 2305 which contains device 2306 implementing an inverter i3 is also a connection herein. Mentioning of the inverter is not required for this connecting aspect. Accordingly, an output that is connected to an input, or an input that is connected to another input and the like may contain an inverter; it may also contain not an inverter.

FIG. 6 shows how the output of shift register element sr3 is provided on the input of shift register element sr1 via an inverter 601 or on an input of a device implementing 2-place function sc2 via an inverter 602. Connecting an output to an input is herein considered also to include connecting an output via an inverter. This is in the interest of brevity. For instance, one may decompose any 2-place function into another 2-place function with an inverter at an input. One may also find equivalent configurations of LFSRs with no inverters or inverters in different places to an LFSR with an inverter in one place. Accordingly, an output connected to an input may include an inverter. It may also not include an inverter or an Identity Inverter.

The steps of the methods which are provided as aspects of the present invention may be implemented in a processor; such a processor may be a general purpose processor or for instance a digital signal processor or a microprocessor. Such a processor may process binary symbols or signals. It may also process n-valued symbols. It may also process n-state symbols as words of binary symbols or signals. They may use A/D and D/A converters to change n-valued symbols in words of lower valued symbols and to convert words of lower valued symbols into n-valued symbols. In case an n-valued symbol is represented as a word of lower valued symbol a storage element of a shift register is assumed to be able all elements of a word representing an n-valued symbol. The n-valued symbols may also be processed by dedicated or custom made switching and storage components. The methods and apparatus may also be implemented in standard binary components, or in programmable devices such as Field Programmable Gate Arrays (FPGAs) or in any other device that will process signals in accordance with one or more aspects of the present invention. While electronic devices are common, aspects of the present invention may also be processed by other type of signals, including optical, chemical, bio-chemical, biological and/or quantum mechanical representation of symbols.

It is pointed out that for convenience the terms scrambler and descrambler are applied herein. A scrambler is generally understood to be at the sending side and a descrambler at the receiving side. This terminology is also applied herein, and descramblers provided herein are self-synchronizing. It is pointed out that one may scramble with apparatus that is called herein a descrambler, and one may descramble with an apparatus that is called herein a scrambler. The self-synchronizing aspect of what is called a descrambler may be lost if one uses a what is called herein a scrambler to descramble. However, if one is able to provide corresponding initial conditions as they relate to scramblers and descramblers, reversal of their roles should not be a problem. Reversal of those roles is explicitly and fully contemplated as an aspect of the present invention.

States or values of logic tables and of signals herein are indicated an integer n, with n=2 in the binary case or n>2 in the multi-state case. The number of states may be considered discrete and expressed as an integer. This does not mean that the state itself has to be represented as an integer. For instance, a signal may have one of 4 discrete states: for instance represented as electrical signals of 1 Volt, 1.25 Volt, 1.5 Volt and 1.75 Volt. If one so desires, one may represent the states as 1, 1.25, 1.5 and 1.75. One may also represent the states as 0, 1, 2 and 3 or as 1, 2, 3 and 4. In the case of implementation of circuits in accordance with Finite Field representation, one may prefer to use 0, 1, 2 and 3 for convenience sake. Such a representation is not required.

While there have been shown, described and pointed out fundamental novel features of the invention as applied to preferred embodiments thereof, it will be understood that various omissions and substitutions and changes in the form and details of the devices and methods illustrated and in its operation may be made by those skilled in the art without departing from the spirit of the invention. It is the intention, therefore, to be limited only as indicated by the scope of the claims appended hereto.

The following patent applications, including the specifications, claims and drawings, are hereby incorporated by reference herein, as if they were fully set forth herein: (1) U.S. Non-Provisional patent application Ser. No. 10/935,960, filed on Sep. 8, 2004, entitled TERNARY AND MULTI-VALUE DIGITAL SCRAMBLERS, DESCRAMBLERS AND SEQUENCE GENERATORS; (2) U.S. Non-Provisional patent application Ser. No. 10/936,181, filed Sep. 8, 2004, entitled TERNARY AND HIGHER MULTI-VALUE SCRAMBLERS/DESCRAMBLERS; (3) U.S. Non-Provisional patent application Ser. No. 10/912,954, filed Aug. 6, 2004, entitled TERNARY AND HIGHER MULTI-VALUE SCRAMBLERS/DESCRAMBLERS; (4) U.S. Non-Provisional patent application Ser. No. 11/042,645, filed Jan. 25, 2005, entitled MULTI-VALUED SCRAMBLING AND DESCRAMBLING OF DIGITAL DATA ON OPTICAL DISKS AND OTHER STORAGE MEDIA; (5) U.S. Non-Provisional patent application Ser. No. 11/000,218, filed Nov. 30, 2004, entitled SINGLE AND COMPOSITE BINARY AND MULTI-VALUED LOGIC FUNCTIONS FROM GATES AND INVERTERS; (6) U.S. Non-Provisional patent application Ser. No. 11/065,836, filed Feb. 25, 2005, entitled GENERATION AND DETECTION OF NON-BINARY DIGITAL SEQUENCES; (7) U.S. Non-Provisional patent application Ser. No. 11/139,835, filed May 27, 2005, entitled MULTI-VALUED DIGITAL INFORMATION RETAINING ELEMENTS AND MEMORY DEVICES; (8) U.S. Non-Provisional patent application Ser. No. 12/137,945, filed on Jun. 12, 2008, entitled METHODS AND SYSTEMS FOR PROCESSING OF N-STATE SYMBOLS WITH XOR AND EQUALITY BINARY FUNCTIONS, (9) U.S. Non-Provisional patent application Ser. No. 11/679,316, filed on Feb. 27, 2007, entitled METHODS AND APPARATUS IN FINITE FIELD POLYNOMIAL IMPLEMENTATIONS; (10) U.S. Non-Provisional patent application Ser. No. 11/696,261, filed on Apr. 4, 2007, entitled BINARY AND N-VALUED LFSR AND LFCSR BASED SCRAMBLERS, DESCRAMBLERS, SEQUENCE GENERATORS AND DETECTORS IN GALOIS CONFIGURATION; (11) U.S. Non-Provisional patent application Ser. No. 11/964,507, filed on Dec. 26, 2007, entitled IMPLEMENTING LOGIC FUNCTIONS WITH NON-MAGNITUDE BASED PHYSICAL PHENOMENA; and (12) U.S. Provisional patent application Ser. No. 61/078,606, filed on Jul. 7, 2008, entitled METHODS AND SYSTEMS FOR N-STATE SYMBOL PROCESSING WITH BINARY DEVICES.

What is claimed:

1. An n-state with n≧2 modified Linear Feedback Shift Register (mLFSR), comprising:
an input enabled to receive a signal having one of n states and an output;
a shift register having at least 2 shift register elements, each shift register element enabled to store a signal having one of n states;
at least one device implementing a first 2-place n-state logic function, the device having a first input, a second input and an output; wherein a signal external to the mLFSR is provided on the first input.

2. The n-state mLFSR as claimed in claim 1, wherein n>2.

3. The n-state mLFSR as claimed in claim 1, wherein the signal external to the mLFSR can be switched between at least two modes.

4. The n-state mLFSR as claimed in claim 1, further comprising:
a second device implementing a reversible 2-place n-state logic function, the second device having a first input, a second input and an output, wherein the first input is enabled to receive a first n-state signal, the second input is connected to the output of the mLFSR and the output of the second device is connected to the input of the LFSR; and
an output enabled to provide a first processed n-state signal.

5. The n-state mLFSR as claimed in claim 1, further comprising:
a third device implementing a second reversible 2-place n-state logic function, the third device having a first input, a second input and an output, wherein the first input is enabled to receive a second n-state signal, the second input is connected to the output of the mLFSR, the output of the third device provides a second processed n-state signal and the second n-state signal is also provided on the input of the mLFSR.

6. The mLFSR as claimed in claim 1, further comprising connecting the output of the mLFSR with the input of the mLFSR and an output enabled to provide an n-state sequence of signals.

7. The mLFSR as claimed in claim 1, wherein the mLFSR is part of a communication system.

8. The mLFSR as claimed in claim 1, wherein the mLFSR is part of a storage system.

9. The mLFSR as claimed in claim 1, wherein the mLFSR is part of a playing device.

10. The mLFSR as claimed in claim 1, wherein the mLFSR is part of a scrambler/descrambler system.

11. A method for processing an n-state signal with n≧2 with a modified Linear Feedback Shift Register (mLFSR), comprising:
inputting the n-state signal on an input of a shift register element of the mLFSR, the mLFSR having at least two shift register elements, the mLFSR including an output;
inputting a signal that depends on the n-state signal on a first input of a first device implementing a 2-place n-state logic function that also includes a second input and an output;
inputting a signal external to the mLFSR on the second input of the first device; and
outputting on the output of the first device a first processed n-state signal.

12. The method as claimed in claim 11, wherein n>2.

13. The n-state mLFSR as claimed in claim 11, wherein the signal external to the mLFSR can be switched between at least two modes.

14. The method as claimed in claim 11, further comprising:
inputting a second n-state signal on a first input of a second device implementing a reversible 2-place n-state logic function;
connecting a second input of the second device to the output of the mLFSR;
connecting an output of the second device an input of the LFSR; and
outputting a second processed n-state signal on an output of the second device.

15. The method as claimed in claim 11, further comprising:
inputting a third n-state signal on a first input of a third device implementing a reversible 2-place n-state logic function;
connecting a second input of the second device to the output of the mLFSR;
providing the third n-state signal on an input of the LFSR; and
outputting a third processed n-state signal on an output of the third device.

16. The method as claimed in claim 11, further comprising connecting the output of the mLFSR with the input of the mLFSR and outputting on an output an n-state sequence of signals.

17. The method as claimed in claim 11, wherein the mLFSR is part of a communication system.

18. The method as claimed in claim 11, wherein the mLFSR is part of a storage system.

19. The method as claimed in claim 11, wherein the mLFSR is part of a playing device.

20. The method as claimed in claim 11, wherein the mLFSR is part of a scrambler/descrambler system.
